(19) United States
(12) Patent Application Publication
(10) Pub. No.: US 2025/0062827 A1
(43) Pub. Date: Feb. 20, 2025

(54) RELAY OPERATION AND ROAMING OPERATION

(71) Applicant: Senscomm Semiconductor Co., Ltd., Suzhou (CN)

(72) Inventors: Sung Jin PARK, Seoul (KR); DAEHONG KIM, Laguna Hills, CA (US)

(21) Appl. No.: 18/807,781

(22) Filed: Aug. 16, 2024

Related U.S. Application Data
(60) Provisional application No. 63/520,589, filed on Aug. 18, 2023.
(60) Provisional application No. 63/674,229, filed on Jul. 22, 2024.

(30) Foreign Application Priority Data
Aug. 12, 2024 (CN) 202411102186.1

(51) Int. Cl. H04B 7/26; H04B 17/309

(52) U.S. Cl. CPC H04B 7/2606; H04B 17/309

(57) ABSTRACT

A wireless communication device for facilitating wireless communication is provided. In the wireless communication device, an access point transmits a measurement announcement frame addressed to one or more neighboring access points and a station. the measurement announcement frame triggers the one or more neighboring access points to transmit a training frame to the station and triggers the station to measure channel information based on training frames from the one or more neighboring access points. The access point receives a measurement report frame from the station, the measurement report frame including the channel information. The access point determines a relay access point based on the measurement report frame and transmits a first data unit to the station via the relay access point.

### CROSS-REFERENCE TO RELATED APPLICATIONS

This application claims benefit of U.S. Provisional Application No. 63/520,589, filed on Aug. 18, 2023, and U.S. Provisional Application No. 63/674,229, filed on Jul. 22, 2024, in the United States Patent and Trademark Office, and China Patent Application No. 202411102186.1, filed on Aug. 12, 2024, in the China National Intellectual Property Administration, the entire contents of which are hereby incorporated by reference.

### TECHNICAL FIELD

The disclosure relates to wireless communication systems, and more particularly to, for example, but not limited to, an efficient relay operation and roaming operation.

### BACKGROUND

If channel status between an access point (AP) station (STA) and a non-AP STA in a wireless network is not good, the AP STA may not send data to the non-AP STA with high modulation and coding scheme (MCS) index. In this scenario, a relay transmission may be used. To perform the relay transmission, one or more nodes need to be selected among neighboring APs. The one or more selected neighboring APs may play the role of relay nodes between the AP STA and the non-AP STA. Therefore, frames and channel measurement to support effective selection of one or more appropriate relay nodes and effective relay transmission need to be introduced.

The description set forth in the background section should not be assumed to be prior art merely because it is set forth in the background section. The background section may describe aspects or embodiments of the present disclosure.

### SUMMARY

Some embodiments may enable AP STAs to select one or more appropriate relay node among neighboring AP STAs for effective relay transmission. Some embodiments may enable AP STAs to perform effective relay transmission using one or more selected relay nodes. Some embodiments may enable the non-AP STA to effectively change its associated AP STA after the relay transmission.

In some embodiments, a wireless communication device for facilitating wireless communication comprises processing circuitry configured to cause: transmitting a measurement announcement frame addressed to one or more neighboring access points and a station, wherein the measurement announcement frame triggers the one or more neighboring access points to transmit a training frame to the station and triggers the station to measure channel information based on training frames from the one or more neighboring access points; receiving a measurement report frame from the station, the measurement report frame including the channel information; determining a relay access point based on the measurement report frame; and transmitting a first data unit to the station via the relay access point.

In some embodiments, transmitting the first data unit to the station via the relay access point comprises: transmitting, to the relay access point, the first data unit to trigger the relay access point to generate a second data unit based on the first data unit and transmit the second data unit to the station.

In some embodiments, the processing circuitry is further configured to cause: receiving, from the station, an acknowledgement frame indicating that the station has successfully received the second data unit via the relay access point.

In some embodiments, the acknowledgement frame is modulated and coded based the lowest modulation and coding scheme (MCS) index.

In some embodiments, the second data unit includes an acknowledgement frame, and the acknowledgement frame is for notifying the wireless communication device that the relay access point successfully received the first data unit.

In some embodiments, the measurement announcement frame includes information indicating the one or more neighboring access points which transmits the training frame, and information indicating the station which transmits the measurement report frame in response to the measurement announcement frame.

In some embodiments, the measurement announcement frame includes information indicating when the one or more neighboring access points transmits the training frame, and information indicating when the station transmits the measurement report frame.

In some embodiments, the measurement announcement frame includes information requesting the station to include, in the measurement report frame, information indicating whether the station has preference to change an access point associated with the station after a relay operation.

In some embodiments, the measurement report frame has information indicating that the station wants to change an access point associated with the station after a relay operation.

In some embodiments, the first data unit includes information instructing the station to change an access point associated with the station after the station transmits an acknowledgement frame to the first data unit.

In some embodiments, a wireless communication device for facilitating wireless communication comprises processing circuitry configured to cause: receiving, from an associated access point having a first data unit to be addressed to the wireless communication device, a measurement announcement frame addressed to one or more neighboring access points and a station, wherein the measurement announcement frame triggers the one or more neighboring access points to transmit a training frame to the station and triggers the station to measure channel information based on training frames from the one or more neighboring access points; transmitting a measurement report to the associated access point, the measurement report frame including the channel information; and receiving a second data unit from a relay access point determined based on the measurement report frame, the second data unit being generated by the relay access point based on the first data unit.

In some embodiments, the processing circuitry is further configured to cause: transmitting, to the associated access point, an acknowledgement frame indicating that the station has successfully received the second data unit via the relay access point.

In some embodiments, the acknowledgement frame is modulated and coded based the lowest modulation and coding scheme (MCS) index.

In some embodiments, the second data unit includes an acknowledgement frame, and the acknowledgement frame is for notifying the associated access point that the relay access point successfully received the first data unit.

In some embodiments, the measurement announcement frame includes information indicating the one or more neighboring access points which transmits the training frame, and information indicating the station which transmits the measurement report frame in response to the measurement announcement frame.

In some embodiments, the measurement announcement frame includes information indicating when the one or more neighboring access points transmits the training frame; and information indicating when the station transmits the measurement report frame.

In some embodiments, the measurement announcement frame includes information requesting the station to include, in the measurement report frame, information indicating whether the station has preference to change an access point associated with the station after a relay operation.

In some embodiments, the measurement report frame has information indicating that the station wants to change an access point associated with the station after a relay operation.

In some embodiments, the first data unit includes information instructing the station to change an access point associated with the station after the station transmits an acknowledgement frame to the first data unit.

In some embodiments, the training frame is a null data physical layer (PHY) protocol data unit (PPDU).

### BRIEF DESCRIPTION OF THE DRAWINGS

FIG. 1 illustrates a schematic diagram of an example wireless communication network.

FIG. 2 illustrates an example of a timing diagram of interframe space (IFS) relationships between stations in accordance with an embodiment.

FIG. 3 shows an OFDM symbol and an OFDMA symbol in accordance with an embodiment.

FIG. 4A illustrates the EHT MU PPDU format in accordance with an embodiment.

FIG. 4B illustrates the EHT TB PPDU format in accordance with an embodiment.

FIG. 5 is a block diagram of an electronic device for facilitating wireless communication in accordance with an embodiment.

FIG. 6 shows a block diagram of a transmitter in accordance with an embodiment.

FIG. 7 shows a block diagram of a receiver in accordance with an embodiment.

FIG. 8 shows a multi-link operation (MLO) in synchronous transmission mode in accordance with an embodiment

FIG. 9 shows an exemplary topology for a relay operation scenario in accordance with an embodiment.

FIG. 10 shows a channel measurement between STA and neighboring APs in accordance with an embodiment.

FIG. 11 shows an exemplary topology for a relay operation scenario in accordance with an embodiment.

FIG. 12 shows an exemplary data transmission through a relay AP in accordance with an embodiment.

FIG. 13 shows a channel measurement between STA and neighboring APs in accordance with an embodiment.

FIG. 14 shows an exemplary data transmission through a relay AP in accordance with an embodiment.

FIG. 15 shows an exemplary topology change after conducting roaming based on the relay operation in accordance with an embodiment.

### DETAILED DESCRIPTION

The detailed description set forth below is intended to describe various implementations and is not intended to represent the only implementation. As those skilled in the art would realize, the described implementations may be modified in various different ways, all without departing from the scope of the present disclosure. Accordingly, the drawings and description are to be regarded as illustrative in nature and not restrictive. Like reference numerals designate like elements.

The below detailed description herein has been described with reference to a wireless LAN system according to the Institute of Electrical and Electronics Engineers (IEEE) 802.11 wireless standards including the current and future amendments. However, a person having ordinary skill in the art will readily recognize that the teachings herein are applicable to other network environments, such as cellular telecommunication networks and wired telecommunication networks.

In some embodiments, apparatus or devices such as an AP STA and a non-AP may include one or more hardware and software logic structure for performing one or more of the operations described herein. For example, the apparatuses or devices may include at least one memory unit which stores instructions that may be executed by a hardware processor installed in the apparatus and at least one processor which is configured to perform operations or processes described in the disclosure. The apparatus may also include one or more other hardware or software elements such as a network interface and a display device.

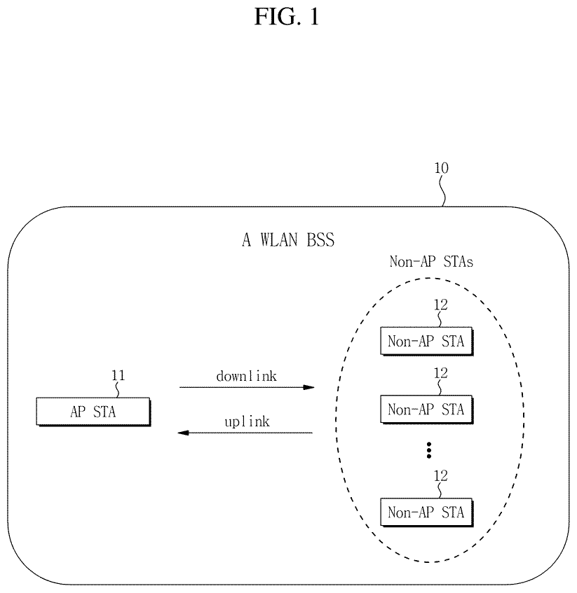

FIG. 1 illustrates a schematic diagram of an example wireless communication network.

Referring to FIG. 1, a basic service set (BSS) 10 may include a plurality of stations (STAs) including an access point (AP) station (AP STA) 11 and one or more non-AP station (non-AP STA) 12. For convenience, the non-AP STA may be referred to interchangeably as a user or an STA. The STAs may share a same radio frequency channel with one out of WLAN operation bandwidth options (e.g., 20/40/80/160/320 MHz). Hereinafter, in some embodiments, the AP STA and the non-AP STA may be referred as AP and STA, respectively. In some embodiments, the AP STA and the non-AP STA may be collectively referred as station (STA).

The plurality of STAs may participate in multi-user (MU) transmission. In the MU transmission, the AP STA 11 may simultaneously transmit the downlink (DL) frames to the multiple non-AP STAs 12 in the BSS 10 based on different resources and the multiple non-AP STAs 12 may simultaneously transmit the uplink (UL) frames to the AP STA 11 in the BSS 10 based on different resources.

For the MU transmission, multi-user multiple input, multiple output (MU-MIMO) transmission or orthogonal frequency division multiple access (OFDMA) transmission may be used. In MU-MIMO transmission, with one or more antennas, the multiple non-AP STAs 12 may either simultaneously transmit to the AP STA 11 or simultaneously receive from the AP STA 11 independent data streams over the same subcarriers. Different frequency resources may be used as the different resources in the MU-MIMO transmission. In OFDMA transmission, the multiple non-AP STAs 12 may either simultaneously transmit to the AP STA 11 or simultaneously receive from the AP STA 11 independent data streams over different groups of subcarriers. Different spatial streams may be used as the different resources in MU-MIMO transmission.

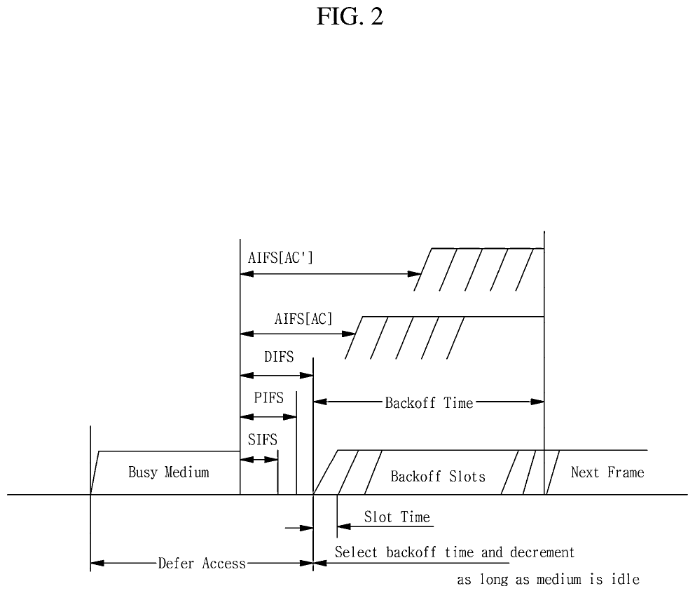

FIG. 2 illustrates an example of a timing diagram of interframe space (IFS) relationships between stations in accordance with an embodiment.

In particular, FIG. 2 shows a CSMA (carrier sense multiple access)/CA (collision avoidance) based frame transmission procedure for avoiding collision between frames in a channel.

A data frame, a control frame, or a management frame may be exchanged between STAs.

The data frame may be used for transmission of data forwarded to a higher layer. Referring to FIG. 2, access is deferred while the medium is busy until a type of IFS duration has elapsed. The STA may transmit the data frame after performing backoff if a distributed coordination function IFS (DIFS) has elapsed from a time when the medium has been idle.

The management frame may be used for exchanging management information which is not forwarded to the higher layer. Subtype frames of the management frame may include a beacon frame, an association request/response frame, a probe request/response frame, and an authentication request/response frame.

The control frame may be used for controlling access to the medium. Subtype frames of the control frame include a request to send (RTS) frame, a clear to send (CTS) frame, and an acknowledgement (ACK) frame. In the case that the control frame is not a response frame of the other frame, the STA may transmit the control frame after performing backoff if the DIFS has elapsed. If the control frame is the response frame of a previous frame, the WLAN device may transmit the control frame without performing backoff when a short IFS (SIFS) has elapsed. The type and subtype of frame may be identified by a type field and a subtype field in a frame control field.

On the other hand, a Quality of Service (QoS) STA may transmit the frame after performing backoff if an arbitration IFS (AIFS) for access category (AC), i.e., AIFS[AC] has elapsed. In this case, the data frame, the management frame, or the control frame which is not the response frame may use the AIFC[AC].

In some embodiments, a point coordination function (PCF) enabled AP STA may transmit the frame after performing backoff if a PCF IFS (PIFS) has elapsed. The PIFS duration may be less than the DIFS but greater than the SIFS.

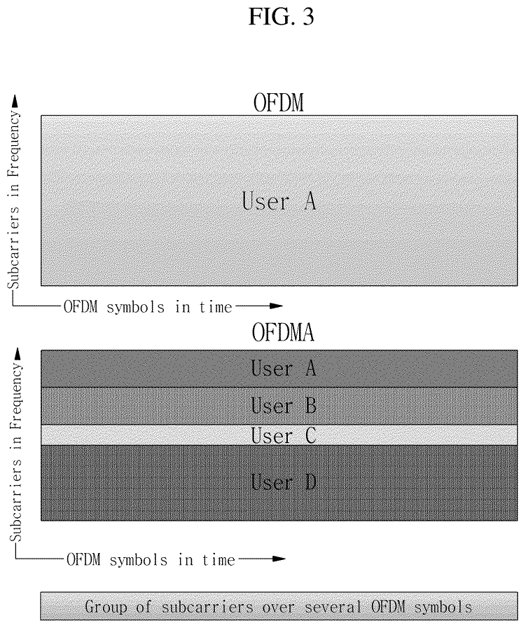

FIG. 3 shows an OFDM symbol and an OFDMA symbol in accordance with an embodiment.

For multi-user access modulation, the orthogonal frequency division multiple access (OFDMA) for uplink and downlink has been introduced in IEEE 802.11ax standard known as High Efficiency (HE) WLAN and will be used in 802.11's future amendments such as EHT (Extreme High Throughput). One or more STAs may be allowed to use one or more resource units (RUs) throughout operation bandwidth to transmit data at the same time. As the minimum granularity, one RU may comprise a group of predefined number of subcarriers and be located at predefined location in orthogonal frequency division multiplexing (OFDM) modulation symbol. Here, non-AP STAs may be associated or non-associated with AP STA when responding simultaneously in the assigned RUs within a specific period such as a short inter frame space (SIFS). The SIFS may refer to the time duration from the end of the last symbol, or signal extension if present, of the previous frame to the beginning of the first symbol of the preamble of the subsequent frame.

The OFDMA is an OFDM-based multiple access scheme where different subsets of subcarriers may be allocated to different users, allowing simultaneous data transmission to or from one or more users with high accurate synchronization for frequency orthogonality. In OFDMA, users may be allocated different subsets of subcarriers which can change from one physical layer (PHY) protocol data unit (PPDU) to the next. In OFDMA, an OFDM symbol is constructed of subcarriers, the number of which is a function of the PPDU bandwidth. The difference between OFDM and OFDMA is illustrated in FIG. 3Error! Reference source not found.

In a case of UL MU transmission, given different STAs with their own capabilities and features, the AP STA may want to have more control mechanism of the medium by using more scheduled access, which may allow more frequent use of OFDMA/MU-MIMO transmissions. PPDUs in UL MU transmission (MU-MIMO or OFDMA) may be sent as a response to the trigger frame sent by the AP. The trigger frame may have STA's information and assign RUs and multiple RUs (MRUs) to STAs. The STA's information in the trigger frame may comprise STA Identification (ID), MCS (modulation and coding scheme), and frame length. The trigger frame may allow an STA to transmit trigger-based (TB) PPDU (e.g., HE TB PPDU or EHT TB PPDU) which is segmented into an RU and all RUs as a response of Trigger frame are allocated to the solicited non-AP STAs accordingly. Hereafter, a single RU and a multiple RU may be referred to as the RU. The multiple RU may include, or consist of, predefined two, three, or more RUs.

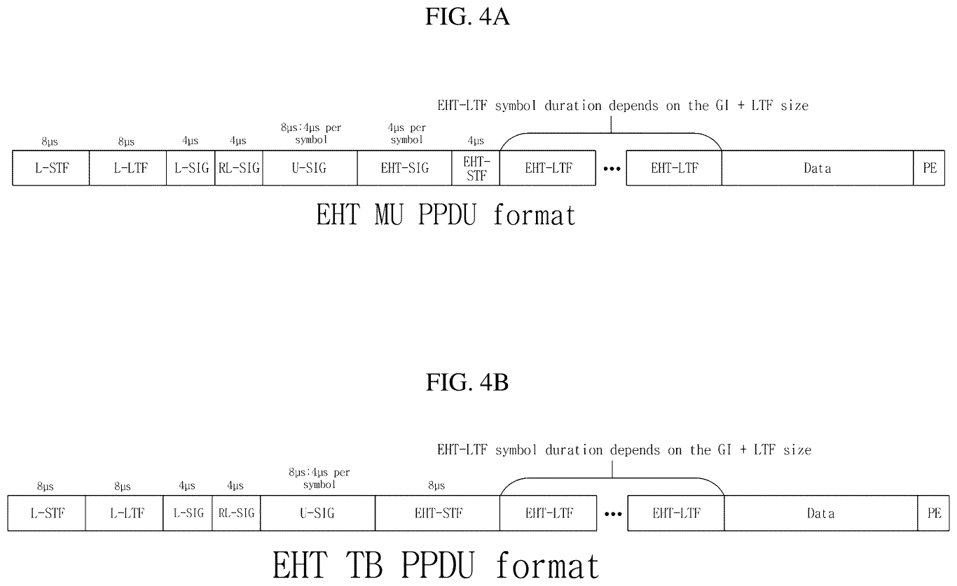

In EHT amendment, two EHT PPDU formats are defined: the EHT MU PPDU and the EHT TB PPDU. Hereinafter, the EHT MU PPDU and the EHT TB PPDU will be described with reference to FIG. 4A and FIG. 4B.

FIG. 4A illustrates the EHT MU PPDU format in accordance with an embodiment.

The EHT MU PPDU may be used for transmission to one or more users. The EHT MU PPDU is not a response to a triggering frame.

Referring to FIG. 4A, the EHT MU PPDU may include, or consist of, an EHT preamble (hereinafter referred to as a PHY preamble or a preamble), a data field, and a packet extension (PE) field. The EHT preamble may include, or consist of, pre-EHT modulated fields and EHT modulated fields. The pre-EHT modulated fields may include, or consist of, a Non-HT short training field (L-STF), a Non-HT long training field (L-LTF), a Non-HT signal (L-SIG) field, a repeated Non-HT signal (RL-SIG) field, a universal signal (U-SIG) field, and an EHT signal (EHT-SIG) field. The EHT modulated fields may include, or consist of, an EHT short training field (EHT-STF) and an EHT long training field (EHT-LTF). In some embodiments, the L-STF may be immediately followed by the L-LTF immediately followed by the L-SIG field immediately followed by the RL-SIG field immediately followed by the U-SIG field immediately followed by the EHT-SIG field immediately followed by the EHT-STF immediately followed by the EHT-LTF immediately followed by the data field immediately followed by the PE field.

The L-STF field may be utilized for packet detection, automatic gain control (AGC), and coarse frequency-offset correction.

The L-LTF field may be utilized for channel estimation, fine frequency-offset correction, and symbol timing.

The L-SIG field may be used to communicate rate and length information.

The RL-SIG field may be a repeat of the L-SIG field and may be used to differentiate an EHT PPDU from a non-HT PPDU, HT PPDU, and VHT PPDU.

The U-SIG field may carry information necessary to interpret EHT PPDUs.

The EHT-SIG field may provide additional signaling to the U-SIG field for STAs to interpret an EHT MU PPDU. Hereinafter, the U-SIG field, the EHT-SIG field, or both may be referred to as the SIG field.

The EHT-SIG field may include one or more EHT-SIG content channel. Each of the one or more EHT-SIG content channel may include a common field and a user specific field. The common field may contain information regarding the resource unit allocation such as the RU assignment to be used in the EHT modulated fields of the PPDU, the RUs allocated for MU-MIMO and the number of users in MU-MIMO allocations. The user specific field may include one or more user fields.

The user field for a non-MU-MIMO allocation may include a STA-ID subfield, a MCS subfield, a NSS subfield, a beamformed subfield, and a coding subfield. The user field for a MU-MIMO allocation may include a STA-ID subfield, a MCS subfield, a coding subfield, and a spatial configuration subfield.

The EHT-STF field may be used to improve automatic gain control estimation in a MIMO transmission.

The EHT-LTF field may enable the receiver to estimate the MIMO channel between the set of constellation mapper outputs and the receive chains.

The data field may carry one or more physical layer convergence procedure (PLCP) service data units (PSDUs).

The PE field may provide additional receive processing time at the end of the EHT MU PPDU.

FIG. 4B illustrates the EHT TB PPDU format in accordance with an embodiment.

The EHT TB PPUD may be used for a transmission of a response to a triggering frame.

Referring to FIG. 4B, the EHT TB PPDU may include, or consist of, an EHT preamble (hereinafter referred to as a PHY preamble or a preamble), a data field, and a packet extension (PE) field. The EHT preamble may include, or consist of, pre-EHT modulated fields and EHT modulated fields. The pre-EHT modulated fields may include, or consist of, a Non-HT short training field (L-STF), a Non-HT long training field (L-LTF), a Non-HT signal (L-SIG) field, a repeated Non-HT signal (RL-SIG) field, and a universal signal (U-SIG) field. The EHT modulated fields may include, or consist of, an EHT short training field (EHT-STF) and an EHT long training field (EHT-LTF). In some embodiments, the L-STF may be immediately followed by the L-LTF immediately followed by the L-SIG field immediately followed by the RL-SIG field immediately followed by the U-SIG field immediately followed by the EHT-STF immediately followed by the EHT-LTF immediately followed by the data field immediately followed by the PE field. In the EHT TB PPUD, the EHT-SIG field is not present because the trigger frame conveys necessary information and the duration of the EHT_STF field in the EHT TB PPUD is twice the duration of the EHT-STF field in the EHT MU PPDU.

Description for each field in the EHT TB PPDU will be omitted because description for each field in the EHT MU PPDU is applicable to the EHT TB PPDU.

For EHT MU PPDU and EHT TB PPUD, when the EHT modulated fields occupy more than one 20 MHz channels, the pre-EHT modulated fields may be duplicated over multiple 20 MHz channels.

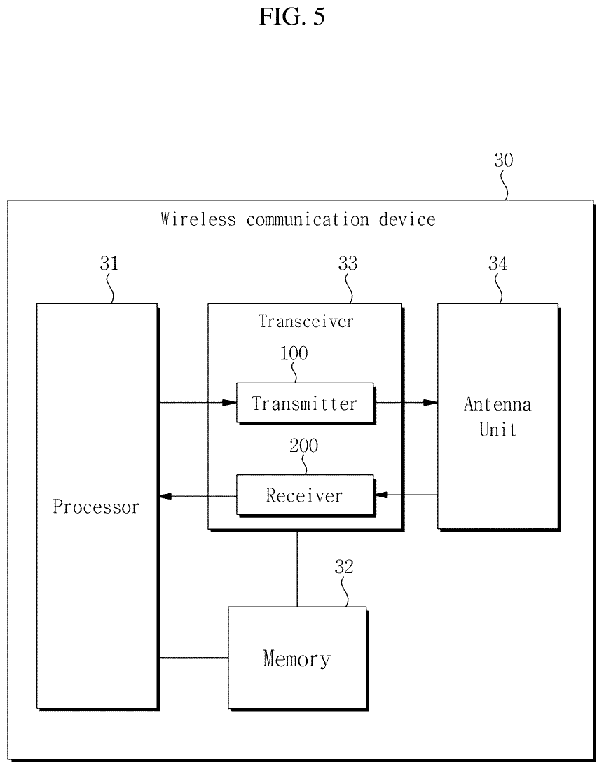

Hereinafter, electronic devices for facilitating wireless communication in accordance with various embodiments will be described with reference to FIG. 5.

FIG. 5 is a block diagram of an electronic device for facilitating wireless communication in accordance with an embodiment.

Referring to FIG. 5, an electronic device 30 for facilitating wireless communication in accordance with an embodiment may include a processor 31, a memory 32, a transceiver 33, and an antenna unit 34. The transceiver 33 may include a transmitter 100 and a receiver 200.

The processor 31 may perform medium access control (MAC) functions, PHY functions, RF functions, or a combination of some or all of the foregoing. In some embodiments, the processor 31 may comprise some or all of a transmitter 100 and a receiver 200. The processor 31 may be directly or indirectly coupled to the memory 32. In some embodiments, the processor 31 may include one or more processors.

The memory 32 may be non-transitory computer-readable recording medium storing instructions that, when executed by the processor 31, cause the electronic device 30 to perform operations, methods or procedures set forth in the present disclosure. In some embodiments, the memory 32 may store instructions that are needed by one or more of the processor 31, the transceiver 33, and other components of the electronic device 30. The memory may further store an operating system and applications. The memory 32 may comprise, be implemented as, or be included in a read-and-write memory, a read-only memory, a volatile memory, a non-volatile memory, or a combination of some or all of the foregoing.

The antenna unit 34 includes one or more physical antennas. When multiple-input multiple-output (MIMO) or multi-user MIMO (MU-MIMO) is used, the antenna unit 34 may include more than one physical antennas.

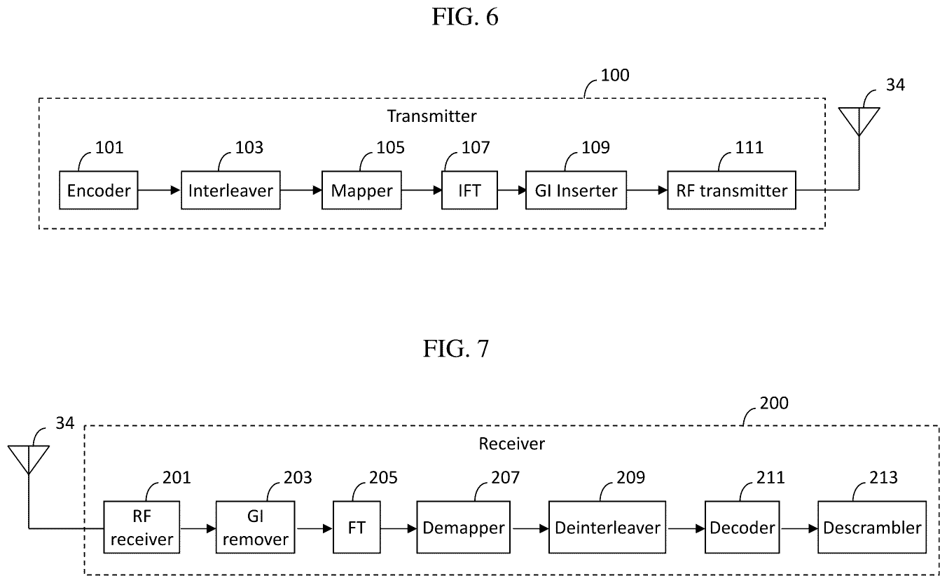

FIG. 6 shows a block diagram of a transmitter in accordance with an embodiment.

Referring to FIG. 7, the transmitter 100 may include an encoder 101, an interleaver 103, a mapper 105, an inverse Fourier transformer (IFT) 107, a guard interval (GI) inserter 109, and an RF transmitter 111.

The encoder 101 may encode input data to generate encoded data. For example, the encoder 101 may be a forward error correction (FEC) encoder. The FEC encoder may include or be implemented as a binary convolutional code (BCC) encoder, or a low-density parity-check (LDPC) encoder.

The interleaver 103 may interleave bits of encoded data from the encoder 101 to change the order of bits, and output interleaved data. In some embodiments, interleaving may be applied when BCC encoding is employed.

The mapper 105 may map interleaved data into constellation points to generate a block of constellation points. If the LDPC encoding is used in the encoder 101, the mapper 105 may further perform LDPC tone mapping instead of the constellation mapping.

The IFT 107 may convert the block of constellation points into a time domain block corresponding to a symbol by using an inverse discrete Fourier transform (IDFT) or an inverse fast Fourier transform (IFFT).

The GI inserter 109 may prepend a GI to the symbol.

The RF transmitter 111 may convert the symbols into an RF signal and transmits the RF signal via the antenna unit 34.

FIG. 7 shows a block diagram of a receiver in accordance with an embodiment.

Referring to FIG. 7, the receiver 200 in accordance with an embodiment may include a RF receiver 201, a GI remover 203, a Fourier transformer (FT) 205, a demapper 207, a deinterleaver 209, and a decoder 211.

The RF receiver 201 may receive an RF signal via the antenna unit 34 and converts the RF signal into one or more symbols.

The GI remover 203 may remove the GI from the symbol.

The FT 205 may convert the symbol corresponding a time domain block into a block of constellation points by using a discrete Fourier transform (DFT) or a fast Fourier transform (FFT) depending on implementation.

The demapper 207 may demap the block of constellation points to demapped data bits. If the LDPC encoding is used, the demapper 207 may further perform LDPC tone demapping before the constellation demapping.

The deinterleaver 209 may deinterleave demapped data bits to generate deinterleaved data bits. In some embodiments, deinterleaving may be applied when BCC encoding is used.

The decoder 211 may decode the deinterleaved data bits to generate decoded bits. For example, the decoder 211 may be an FEC decoder. The FEC decoder may include a BCC decoder or an LDPC decoder. In order to support the HARQ procedure, the decoder 211 may combine a retransmitted data with an initial data.

The descrambler 213 may descramble the descrambled data bits based on a scrambler seed.

Hereinafter, a multi-link operation (MLO) in accordance with an embodiment will be described.

The IEEE 802.11be Extremely High Throughput (EHT) task group is currently developing the next generation Wi-Fi standard to achieve higher data rate, lower latency, and more reliable connection to enhance user experience. One of the key features of the IEEE 802.11be standard is a multi-link operation (MLO). As most of the AP STAs and the non-AP STAs incorporate dual-band or tri-band capabilities, the newly developed MLO feature may enable packet-level link aggregation in the MAC layer across different PHY links. By performing load balancing according to traffic requirements, the MLO may achieve significantly higher throughput and lower latency for enhanced reliability in a heavily loaded network. With the MLO capability, a multi-link device (MLD) includes multiple affiliated devices to the upper logical link control (LLC) layer, allowing concurrent data transmission and reception in multiple channels across a single or multiple frequency bands in 2.4 GHz, 5 GHz and 6 GHz.

There exists Wi-Fi technologies that allow a Wi-Fi device to connect to a single link and enable the Wi-Fi device to switch among 2.4 GHz, 5 GHz and 6 GHz bands. However, such Wi-Fi devices typically have a switching overhead or delay of up to 100 ms. Therefore, the MLO is highly desirable for real-time applications like video calls, wireless VR headsets, cloud gaming and other latency-sensitive applications. The IEEE 802.11be draft specification defines different channel access methods according to two transmission modes: asynchronous and synchronous modes. Under asynchronous transmission mode, the MLD transmits frames asynchronously across multiple links without aligning the starting time. In contrast, in synchronous transmission mode, the starting times are aligned across the links. In either mode, the links may have their own primary channel and parameters, including Packet Protocol Data Unit (PPDU), Modulation and Coding Scheme (MCS), Enhanced Distributed Channel Access (EDCA), etc.

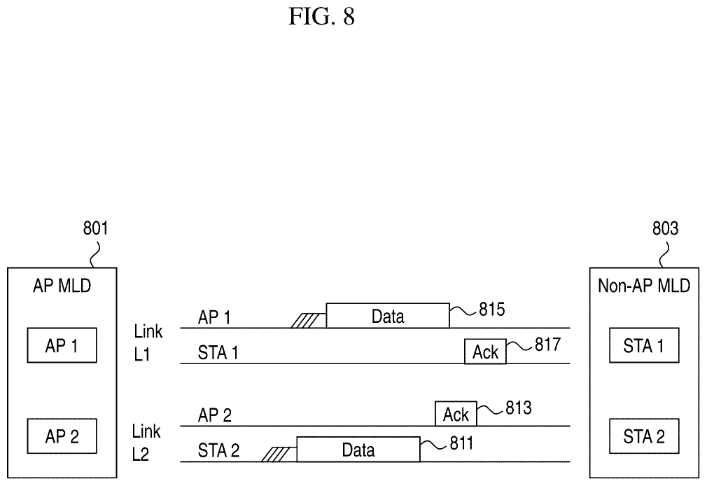

FIG. 8 shows a multi-link operation (MLO) in synchronous transmission mode in accordance with an embodiment.

Referring to FIG. 8, the AP MLD 801 may comprise a plurality of APs including AP 1 and AP2, and the non-AP MLD may comprise a plurality of STAs including STA 1 and STA 2. The AP 1 may have a buffer containing data units including data units to be transmitted to the STA 1, the AP 2 may have a buffer containing data units including data units to be transmitted to the STA 2, the STA 1 may have a buffer containing data units including data units to be transmitted to the AP 1, and the STA 2 may have a buffer containing data units including data units to be transmitted to the AP 2.

The STA 2 of the non-AP MLD 803 may check whether a backoff counter for the link L2 reaches 0. When the backoff counter for the link L2 reaches 0, the STA 2 of the non-AP MLD 803 may transmit the data unit 811 to the AP 2 via the link L2. The AP 2 of the AP MLD 801 may transmit an Ack frame 813 for the data unit 811 to the STA 2 via the link L2 a SIFS after the AP 2 successfully receives the data unit 811.

Even during the AP 2's reception of the data unit 811, the AP 1 of the AP MLD 801 may check whether a backoff counter for the link L1 reaches 0. When the backoff counter for the link L1 reaches 0, the AP 1 of the AP MLD 801 may transmit the data unit 815 to the STA 1 via the link L1 even during the AP 2's reception of the data unit 811. The STA 1 of the non-AP MLD 803 may transmit an Ack frame 817 for the data unit 815 to the AP 1 via link L1 a SIFS after the STA 1 successfully receives the data unit 815.

In the embodiment of FIG. 8, the AP MLD 801 may complete receiving the data unit 811 via the link L2 first, and then the non-AP MLD 803 may complete receiving the data unit 815 via the link L1.

Hereinafter, an exemplary topology for a relay operation scenario in accordance with an embodiment will be described.

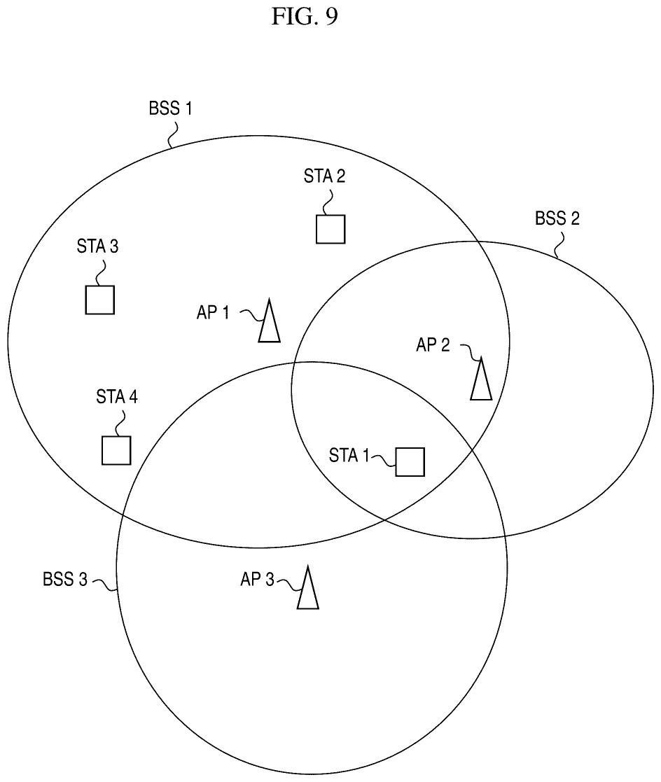

FIG. 9 shows an exemplary topology for a relay operation scenario in accordance with an embodiment.

A wireless network shown in FIG. 9 includes a plurality of APs 1, 2, and 3 and a plurality of STAs 1, 2, 3, and 4. The APs 2 and 3 are neighboring APs of the AP 1. Each AP may perform an association with STAs and forms its own BSS. Each AP may transmit data to an associated STA and may receive data from the associated STA.

Referring to FIG. 9, APs 1, 2, and 3 form BSS 1, 2, and 3, respectively. AP 1 is associated with STAs 1, 2, 3, and 4.

If the link quality or channel status is getting poor between the STA within a BSS and the AP that has associated with the STA, the relay operation can be considered which improves the communication quality. In some embodiments, the relay operation can be performed using a neighboring AP as a relay device.

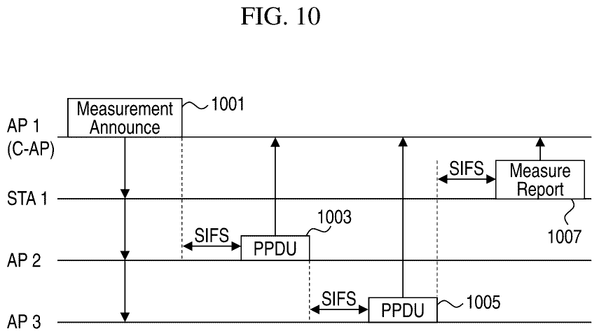

Hereinafter, a channel (link) measurement between STA and neighboring APs in accordance with an embodiment will be described with reference to FIG. 10.

FIG. 10 shows a channel measurement between STA and neighboring APs in accordance with an embodiment.

The AP 1 has data to transmit to STA 1 in the buffer. If the link quality between AP 1 and STA 1 is not good, the AP 1 may not send data to STA 1 using a high MCS index and a high number of spatial stream (Nss). This is because the STA 1 may not receive the data sent by the AP 1 successfully if the AP 1 sends the data using a high MCS index and a high Nss. In this scenario, the AP 1 can send data to the STA 1 using high MCS and Nss if relay operation is used. The AP 1 that tries to send data to the STA plays the role of the control AP (C-AP) that controls the relay operation. An AP among the neighboring APs AP2 and AP3 may play the role of the relay AP (R-AP) which has good link quality or channel status with the STA (STA 1) associated with the C-AP. The C-AP may receive a report from the STA 1 associated with the C-AP. In some embodiments, the report may include channel information measured by the STA 1 from a signal sent by neighboring APs. In some embodiments, the channel information may include signal strength and/or channel state information (CSI) measured by the STA 1 from a signal sent by neighboring APs. The C-AP may select an R-AP among neighboring APs based on the reported information and performs relay operation by using the R-AP.

The C-AP transmits the measurement announce frame at 1001. In some embodiments, the measurement announce frame may be addressed to STA 1 and neighboring APs AP 2 and AP 3. In some embodiments, the measurement announce frame may contain an indication that instructs STA 1 to receive signals transmitted by neighboring APs AP2 and AP3 and measure channel information. In some embodiment, the measurement announce frame may contain an indication instructing neighboring APs AP 2 and AP 3 to transmit PPDUs such as NDP so that STA 1 can measure channel information by using the PPDUs transmitted by neighboring APs AP 2 and AP 3. In some embodiment, the measurement announce frame may contain information indicating when the neighboring APs AP 2 and AP 3 starts sending PPDUs. In some embodiments, the measurement announce frame may contain at least one of information indicating the one or more neighboring access points which transmits a training frame, information indicating the station which transmits the measurement report frame in response to the measurement announcement frame, information indicating when the one or more neighboring access points transmits a training frame, and information indicating when the station transmits the measurement report frame. In some embodiments, the training frame may a null data PPDU (NDP).

In response to the measurement announce frame, the neighboring APs AP 2 and AP 3 transmit PPDUs such as NDP as indicated by the measurement announce frame. In some embodiments, according to the measurement announce frame, at 1003, the neighboring AP 2 sends a PPDU a SIFS after receiving the measurement announce frame. At 1005, the AP 3 sends a PPDU a SIFS after the AP 2 sends PPDU.

The STA 1 may receive the PPDUs transmitted by AP 2 and AP 3 independently, measure channel information based on the PPDUs. The STA 1 transmits, to the C-AP, a measure report frame including channel information of neighboring APs, at 1007.

After the C-AP receives the measure report frame, the C-AP may select an R-AP based on information in the measure report frame. In some embodiments, the C-AP may configure a relay AP group which can be used for relay transmission and includes the selected R-AP into the relay AP group. In some embodiments, the C-AP may perform the same operation with other STAs associated with C-AP and configure the relay AP group based on the reported measurement results from the STAs.

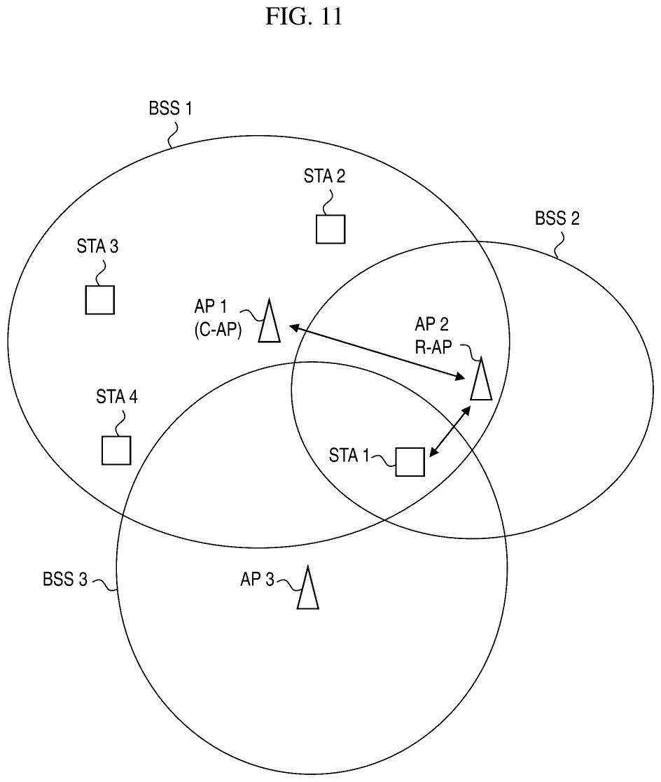

FIG. 11 shows an exemplary topology for a relay operation scenario in accordance with an embodiment.

As described above with reference to FIG. 10, when the channel status or link quality between the C-AP and the STA 1 gets poor and it is difficult to achieve high throughput by using high MCS and Nss, the C-AP may use Relay operation to transmit data to the STA 1. Among APs in the relay AP group, the C-AP selects an AP that can send signals with the largest signal strength to STA 1. The selected AP may become R-AP which participates in relay transmission.

Referring to FIG. 11, the C-AP selects the AP 2 as the R-AP because signals received by the STA 1 from AP 2 have the largest signal strength among signals received by the STA 1 from the neighboring APs.

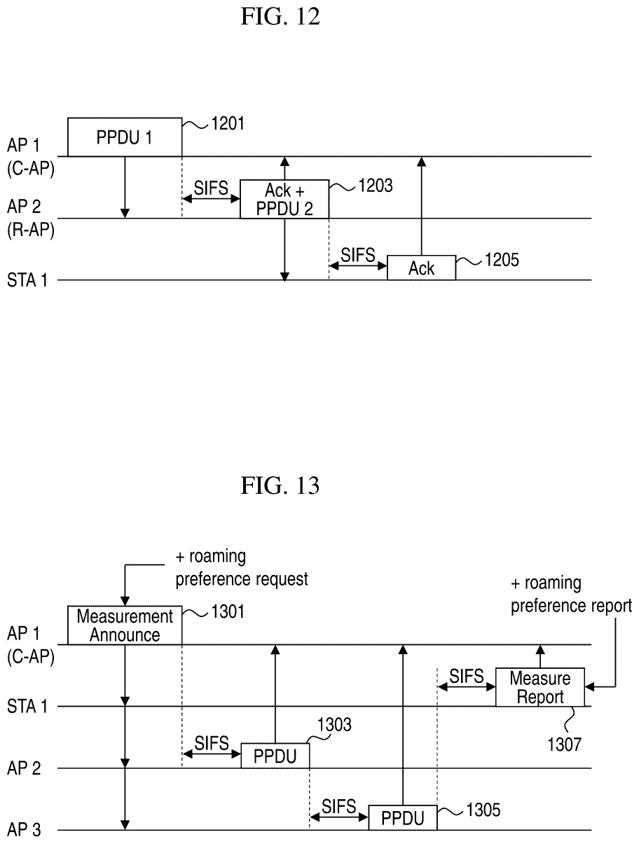

Hereinafter, the C-AP's data transmission through the R-AP in accordance with an embodiment will be described with reference to FIG. 12.

FIG. 12 shows an exemplary data transmission through a relay AP in accordance with an embodiment.

Referring FIG. 12, the AP 1 plays the role of the C-AP and the AP 2 is selected to play the role of the R-AP.

If the C-AP has data to be transmitted to the STA 1, the C-AP may transmit a PPDU 1 including the data to the R-AP, at 1201.

At 1203, in response to the PPDU 1 from the C-AP, the R-AP transmits a PPDU 2 a SIFS after the PPDU 1 is received from the C-AP. The PPDU 2 transmitted by the R-AP includes data in the PPDU 1. In some embodiments, the PPDU 2 may be the same as the PPDU 1. In some embodiments, the PPDU 2 may be the PPDU 1 in which an acknowledgement (ACK) frame is included. The PPDU 2 is addressed to STA 1. In some embodiments, the ACK frame included in the PPDU transmitted by the R-AP may be addressed to the C-AP to indicate that the R-AP successfully received the PPDU transmitted by the C-AP. In some embodiments, the preamble of the PPDU 2 may be the same as the preamble of the PPDU 1. In some embodiments, the MAC header of the PPDU 2 may be the same as the MAC header of the PPDU 1.

At 1205, in response to the PPDU 2 received from the R-AP, STA 1 transmits an ACK frame to C-AP a SIFS after the PPDU 2 is received. The ACK frame is addressed to the C-AP to indicate that the STA 1 successfully received the PPDU 1 via the R-AP. In some embodiments, the ack frame may be transmitted by using MCS 0 which is the lowest MCS index.

Hereinafter, a roaming process based on a relay operation in accordance with an embodiment will be described.

Upon successfully receiving the PPDU 1 transmitted from the R-AP, the STA 1 may perform roaming from the AP 1 to AP 2 to change an AP associated with the STA 1.

Since the link quality between STA 1 and the AP 2 is better than the link quality between STA 1 and the C-AP, it may be more beneficial to conduct roaming from the C-AP to the R-AP after performing new association with R-AP and configuration of new BSS with R-AP.

For roaming based on relay operation, when the C-AP instructs the STA 1 to measure the signals of neighboring APs, the C-AP may request the STA 1 to send information indicating whether the STA 1 has preference to conduct roaming to other AP. When the STA 1 reports the measurement result to the C-AP, the STA 1 may inform the C-AP of which AP is suitable for roaming among neighboring APs. When the C-AP transmits a data PPDU to the STA 1 through relay transmission, the C-AP may include, in the data PPDU, information informing the STA 1 of an AP to be a roaming AP after relay transmission. After the relay transmission is completed, the STA 1 may perform roaming according to the indication in the PPDU received from the relay transmission to change an AP associated with the STA 1.

FIG. 13 shows a channel measurement between STA and neighboring APs in accordance with an embodiment.

Referring FIG. 13, the AP 1 plays the role of the C-AP.

The C-AP transmits the measurement announce frame at 1301. In some embodiments, the measurement announce frame may be addressed to STA 1 and neighboring APs AP 2 and AP 3. In some embodiments, the measurement announce frame may contain an indication that instructs STA 1 to receive signals transmitted by neighboring APs AP2 and AP3 and measure channel information. In some embodiment, the measurement announce frame may contain an indication instructing neighboring APs AP 2 and AP 3 to transmit PPDUs such as NDP so that STA 1 can measure channel information by using the PPDUs transmitted by neighboring APs AP 2 and AP 3. In some embodiment, the measurement announce frame may contain information indicating when the neighboring APs AP 2 and AP 3 starts sending PPDUs. In some embodiments, the measurement announce frame may contain at least one of information indicating the one or more neighboring access points which transmits a training frame, information indicating the station which transmits the measurement report frame in response to the measurement announcement frame, information indicating when the one or more neighboring access points transmits a training frame, and information indicating when the station transmits the measurement report frame. In some embodiments, the measurement announce frame may contain a roaming preference request field indicating that the C-AP requests the STA 1 to include, in the measure report frame, a roaming preference report field indicating whether the STA 1 has preference to conduct roaming to other AP.

In response to the measurement announce frame, the neighboring APs AP 2 and AP 3 transmit PPDUs such as NDP as indicated by the measurement announce frame. In some embodiments, according to the measurement announce frame, at 1303, the neighboring AP 2 sends a PPDU a SIFS after receiving the measurement announce frame. At 1305, the AP 3 sends a PPDU a SIFS after the AP 2 sends PPDU.

The STA 1 may receive the PPDUs transmitted by AP 2 and AP 3 independently, measure channel information based on the PPDUs. The STA 1 transmits, to the C-AP, a measure report frame including channel information of neighboring APs, at 1307. In some embodiments, the measure report frame may contain a roaming preference report field. The roaming preference report field may represent information indicating that the STA 1 has preference to conduct roaming to another AP among neighboring APs or information indicating that the STA 1 wants to conduct roaming to an AP transmitting a signal with the highest signal strength to the STA1 among neighboring APs.

After the C-AP receives the measure report frame, the C-AP may select an R-AP based on information in the measure report frame. In some embodiments, the C-AP may configure a relay AP group which can be used for relay transmission and includes the selected R-AP into the relay AP group. In some embodiments, the C-AP may perform the same operation with other STAs associated with C-AP and configure the relay AP group based on the reported measurement results from the STAs.

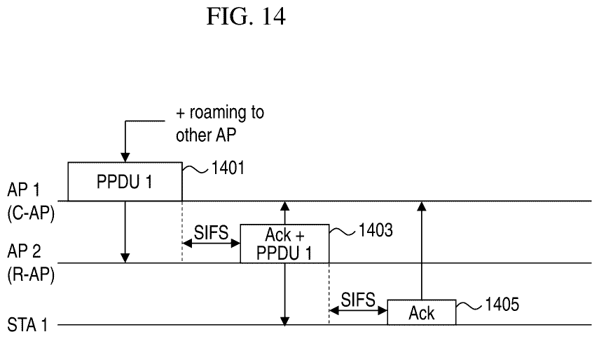

FIG. 14 shows an exemplary data transmission through a relay AP in accordance with an embodiment.

Referring FIG. 14, the AP 1 plays the role of the C-AP and the AP 2 is selected to play the role of the R-AP.

If the C-AP has data to be transmitted to the STA 1, the C-AP may transmit a PPDU 1 including the data to the R-AP, at 1401. In some embodiments, the PPDU 1 may include a roaming to other AP field. In some embodiments, the roaming to other AP field may include information instructing the STA 1 to conduct roaming to other AP after sending an ACK frame to the C-AP or after the relay transmission. In some embodiments, the roaming to other AP field may include information instructing the STA 1 to conduct roaming to an AP which the STA 1 wants to roam to. In some embodiments, the roaming to other AP field may include an indication or an identifier of an AP to which the STA 1 should roam after sending an ACK frame to the C-AP or after the relay transmission. In some embodiments, the roaming to other AP field may include information instructing that the STA 1 to conduct roaming to the R-AP after sending an ACK frame to the C-AP or after the relay transmission.

At 1403, in response to the PPDU 1 from the C-AP, the R-AP transmits a PPDU 2 a SIFS after the PPDU 1 is received from the C-AP. The PPDU 2 transmitted by the R-AP includes data in the PPDU 1. In some embodiments, the PPDU 2 may be the same as the PPDU 1. In some embodiments, the PPDU 2 may be the PPDU 1 in which an acknowledgement (ACK) frame is included. The PPDU 2 is addressed to STA 1. In some embodiments, the ACK frame included in the PPDU transmitted by the R-AP may be addressed to the C-AP to indicate that the R-AP successfully received the PPDU transmitted by the C-AP. In some embodiments, the preamble of the PPDU 2 may be the same as the preamble of the PPDU 1. In some embodiments, the MAC header of the PPDU 2 may be the same as the MAC header of the PPDU 1.

At 1405, in response to the PPDU 2 received from the R-AP, STA 1 transmits an ACK frame to C-AP a SIFS after the PPDU 2 is received. The ACK frame is addressed to the C-AP to indicate that the STA 1 successfully received the PPDU 1 via the R-AP. In some embodiments, the ack frame may be transmitted by using MCS 0.

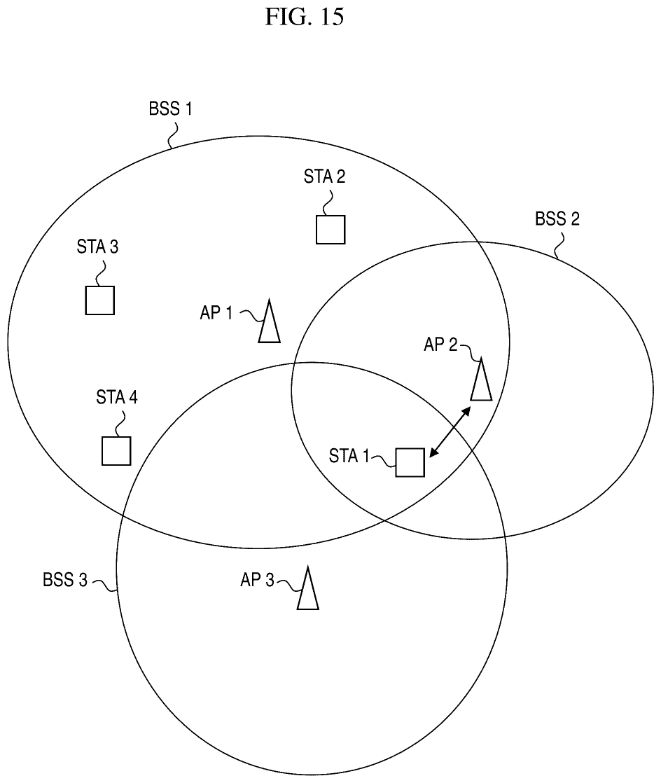

FIG. 15 shows an exemplary topology change after conducting roaming based on the relay operation in accordance with an embodiment.

As shown in FIG. 15, after the STA 1 conducts roaming based on the relay operation from AP 1 to AP 2, the STA 1 is associated with the AP 2 and the AP 2 plays the role of the C-AP.

The various illustrative blocks, units, modules, components, methods, operations, instructions, items, and algorithms may be implemented or performed with a processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A wireless communication device for facilitating wireless communication, comprising processing circuitry configured to cause:
transmitting a measurement announcement frame addressed to one or more neighboring access points and a station, wherein the measurement announcement frame triggers the one or more neighboring access points to transmit a training frame to the station and triggers the station to measure channel information based on training frames from the one or more neighboring access points;
receiving a measurement report frame from the station, the measurement report frame including the channel information;
determining a relay access point based on the measurement report frame; and
transmitting a first data unit to the station via the relay access point.

2. The wireless communication device of claim 1, wherein transmitting the first data unit to the station via the relay access point comprises:
transmitting, to the relay access point, the first data unit to trigger the relay access point to generate a second data unit based on the first data unit and transmit the second data unit to the station.

3. The wireless communication device of claim 2, wherein the processing circuitry is further configured to cause:
receiving, from the station, an acknowledgement frame indicating that the station has successfully received the second data unit via the relay access point.

4. The wireless communication device of claim 3, wherein the acknowledgement frame is modulated and coded based the lowest modulation and coding scheme (MCS) index.

5. The wireless communication device of claim 2, wherein the second data unit includes an acknowledgement frame,
the acknowledgement frame is for notifying the wireless communication device that the relay access point successfully received the first data unit.

6. The wireless communication device of claim 1, wherein the measurement announcement frame includes information indicating the one or more neighboring access points which transmits the training frame, and information indicating the station which transmits the measurement report frame in response to the measurement announcement frame.

7. The wireless communication device of claim 1, wherein the measurement announcement frame includes information indicating when the one or more neighboring access points transmits the training frame, and information indicating when the station transmits the measurement report frame.

8. The wireless communication device of claim 1, wherein the measurement announcement frame includes information requesting the station to include, in the measurement report frame, information indicating whether the station has preference to change an access point associated with the station after a relay operation.

9. The wireless communication device of claim 1, wherein the measurement report frame has information indicating that the station wants to change an access point associated with the station after a relay operation.

10. The wireless communication device of claim 1, wherein the first data unit includes information instructing the station to change an access point associated with the station after the station transmits an acknowledgement frame to the first data unit.

11. A wireless communication device for facilitating wireless communication, comprising processing circuitry configured to cause:
receiving, from an associated access point having a first data unit to be addressed to the wireless communication device, a measurement announcement frame addressed to one or more neighboring access points and a station, wherein the measurement announcement frame triggers the one or more neighboring access points to transmit a training frame to the station and triggers the station to measure channel information based on training frames from the one or more neighboring access points;
transmitting a measurement report frame to the associated access point, the measurement report frame including the channel information; and
receiving a second data unit from a relay access point determined based on the measurement report frame, the second data unit being generated by the relay access point based on the first data unit.

12. The wireless communication device of claim 11, wherein the processing circuitry is further configured to cause:
transmitting, to the associated access point, an acknowledgement frame indicating that the station has successfully received the second data unit via the relay access point.

13. The wireless communication device of claim 12, wherein the acknowledgement frame is modulated and coded based the lowest modulation and coding scheme (MCS) index.

14. The wireless communication device of claim 11, wherein the second data unit includes an acknowledgement frame,
the acknowledgement frame is for notifying the associated access point that the relay access point successfully received the first data unit.

15. The wireless communication device of claim 11, wherein the measurement announcement frame includes information indicating the one or more neighboring access points which transmits the training frame, and information indicating the station which transmits the measurement report frame in response to the measurement announcement frame.

16. The wireless communication device of claim 11, wherein the measurement announcement frame includes information indicating when the one or more neighboring access points transmits the training frame; and information indicating when the station transmits the measurement report frame.

17. The wireless communication device of claim 11, wherein the measurement announcement frame includes information requesting the station to include, in the measurement report frame, information indicating whether the station has preference to change an access point associated with the station after a relay operation.

18. The wireless communication device of claim 11, wherein the measurement report frame has information indicating that the station wants to change an access point associated with the station after a relay operation.

19. The wireless communication device of claim 11, wherein the first data unit includes information instructing the station to change an access point associated with the station after the station transmits an acknowledgement frame to the first data unit.

20. The wireless communication device of claim 11, wherein the training frame is a null data physical layer (PHY) protocol data unit (PPDU).
